(19) United States
(12) Patent Application Publication
(10) Pub. No.: US 2004/0079113 A1
(43) Pub. Date: Apr. 29, 2004

(54) Method for measurement and regulation of quality-determining parameters for the raw smelt in glass furnaces

(76) Inventors: Frank Hegewald, Cottbus (DE); Peter Hemmann, Freiberg (DE); Helmut Heelemann, Kiekebusch (DE)

Correspondence Address: HAHN LOESER & PARKS, LLP, TWIN OAKS ESTATE, 1225 W. MARKET STREET, AKRON, OH, 44313, US

(21) Appl. No.: 10/450,548

(22) PCT Filed: Dec. 13, 2001
(86) PCT No.: PCT/EP01/14665

(30) Foreign Application Priority Data
Dec. 14, 2000 (DE) 100 65 882.2
Dec. 14, 2000 (DE) 100 65 883.0
Dec. 14, 2000 (DE) 100 65 884.9

(51) Int. Cl. C03B 5/24

(52) U.S. Cl. 65/29.16; 65/29.18; 65/29.11

(57) ABSTRACT

The invention relates to a method for measurement and simple and fixedly structured regulation of quality-determining parameters of the glass bath. According to the invention batch coverage, batch compression, the position of the thermal key points of heat sinks and sources, in particular the glass bath surface and the flames, are optically measured, compared as set values or in subsequent regulation as control parameters and adjusted by fuel actuation, fuel distribution, burner inlet pressure, implementation of additional heating or bubbling throughput.

In the image section of a furnace chamber camera, which is adjusted in real proportions, a distinction is made in pixel-wise manner as batch or glass, preferably after color weighting. At the top of the regulating hierarchy a regulating circuit regulates the degree of batch coverage. The proportion of batch listed in image line-wise manner in the transverse direction of the furnace and its linearised axial configuration in the melting zone is determined as batch compression which is essential for the method and which is governed by the recirculation flow and it is used as an actual value input of a batch drift regulating circuit. In transverse flame furnaces after positional deviation of the flame-axial glass hotspots from the central position axially of the furnace, which is most intensive in terms of flow and which is fixed in respect of a set value, a firing control regulating circuit sends a flame length control parameter to its subsequent flame length regulating circuit which in the firing period currently regulates the flame key point. A disturbance-variable feed-forward system at the control regulating circuit avoids overheating of the edges of the withdrawing port. Intensive cross-flow mixing and marked reaction space separation of the melting and refining zone is the quality assurance which is typical of the method.

The invention concerns a method for measurement and regulation of quality-determining parameters of the rough melt in glass-melting furnaces, in particular for simply and fixedly structured regulation of the degree of batch coverage and axial and radial batch compression as ascertained parameters of the glass bath surface, which are relevant in terms of the glass flow and can be well regulated and are optically measured. Fixedly or manually predetermined set values in respect of optical parameters of the glass surface such as batch coverage, batch drift and position of the transverse hotspot which represent the glass flow intensity and the reaction space separation of the melting and refining part in the lower furnace, supplemented by a speedy consequential regulating circuit which is a flame length regulating circuit are an essential feature.

Conventional furnace regulating methods regulate upper furnace parameters which are extraneous in respect of quality or relationships which are obscure and in addition, in glass-melting furnaces, with a long delay time, are difficult to regulate.

Continuous glass melting is a technologically demanding process which hitherto has been characterised by long delay times and ambiguous reactions in regard to the regulating section. The direct regulation of status parameters of the glass bath, which are conventionally assumed to involve quality assurance, failed either in consideration of the very fact of measurement thereof or in regard to excessively long delay times. The regulation of a small (faster) model furnace as a solution to the problem characterises the apparently hopeless situation. For, this can only be addressed as a solution of desperation.

One motivation for using furnace arch roof temperature regulation which determines the level by an automation procedure lies in the short delay time of the furnace roof temperature. Nonetheless that regulation procedure is technologically disadvantageous. In some cases it has a downright blinding effect for it is not the roof but the counterpart in heat exchange, the glass, that is to be melted. For example, in regard to the predominant number of disturbance parameters and measures in firing control in the furnace, it is true to say that higher measurement values in respect of the roof temperature indicate colder glass, which however is the important consideration and which is also actually the aim involved. Therefore that regulating procedure cannot in any way be the sole high-level regulating circuit in the cascade or sequence of a regulating concept which is progressive and new or indeed complete in terms of automation technology. It is in conflict therewith.

Serious systematic disadvantages of speedy furnace roof temperature regulation are eliminated by an old procedure known from P3610365.9 as FTR-regulation ‘Method for currently technological regulation of the upper furnace heating of glass-melting furnaces’ which also includes an implementation of regulation in accordance with control parameters of a higher-level heat-technology computation model. If however, as outlined above, a so relatively clearly understandable regulating circuit as the roof temperature can already mislead the operator in many different ways and leads him away from an insight into the internal process relationships, how much more does that risk arise due to the regulation of just any phenomena, with all possible control values, as is an essential feature of so-called fuzzy regulating systems, for example in accordance with EP 0 976 685 T1. That regulating concept is disadvantageous in terms of the compellingly necessary, lastingly accompanying analytical work of the melting technologist and can be of only brief success for a tight, well-known technological context.

What is common to all those concepts however is that reaction space separation of the melting and refining parts, and quality-determining glass mixing, caused by flow considerations, in the lower furnace, and in particular the cross-flow principle, are neither at the focal point of regulation nor are they explicitly the aim thereof. They relate to upper furnace parameters and thus from the outset are neither intended nor suitable for direct and relatively independent regulation of lower furnace parameters, that is to say for the sole location at which the glass is produced.

Because of the remaining extremely varied and dynamic boundary conditions however a quality-assuring regulation concept must aim in a logically clear fashion at those quality parameters, it must be as readily comprehensible as possible, but it should be transformed on to directly measurable parameters, the regulatability of which is good. In other words: the relationship of compensation or adjustment time to delay time should be as great as possible in regard to these operational parameters.

The problem here is that the crucial parameters in terms of glass quality of the lower furnace or the glass bath where the glass is produced must be causally subjected to regulation in order to be able to produce glass in a specifically targeted fashion with a higher level of stability and effectively in glass furnaces.

Therefore the object of the invention is to provide methods with which the attainment of indirect measurement values of quality-determining parameters of the rough melt, evaluation and regulation thereof is possible, in order to stabilise and qualitatively and economically improve the glass manufacturing process in tank furnaces.

It was surprisingly found that the degree of overall coverage but in particular the batch distribution as the local gradient thereof in the axial direction of the furnace or differential quotient—the batch drift—gives a great deal of information about the return flow. As the forward movement of the batch lumps or portions depends on the infeed impulse of the feeder machine, the thrust action of the flames and the distribution pressure at the surface, which generally remain similar or are to be kept similar, for the same melting efficiency the degree of compactness or compression of the batch lumps or portions is a measurement in respect of the returning effect of the swirl flow which flows back at the surface. In the broader sense in that respect the smelting flow which is greater by the melting capacity and which has a downward suction effect is considered as a condition which promotes that flow in the same direction. The surface recirculation flow determines solely the smelting effect due to convection and at the same time dominates the level of mixing intensity and reaction space separation of the rough melt and the refining region and is particularly significant as a difference sub-flow. It can scarcely be calculated but it can be observed or measured at the surface. It affords the causally ‘deep insight’ to where the glass is produced and is characteristic in respect of the smelting dynamics. In terms of its strength, in dependence on melting capacity, the existence of an optimum is asserted, the maintenance of which or the deviation of which is to be numerically reproducibly determined by the measuring method according to the invention. For characteristic batch compression it is possible in a simplification to apply Newton's law of flow in its generally applicable form for the frictional force F between a plate and a fluid:

F=−n*A*dv/dx

Therein dv/dx is the speed gradient of the fluid at a vertical spacing from the plate. A is the contact surface area of the plate with the fluid flowing thereto parallel (the glass recirculation return flow) and n is the dynamic viscosity of the fluid. If a plate of the batch layer is considered in a simplification as being completely floating Newton's law of friction can be applied to determine the returning frictional force due to the recirculation return flow, acting on the batch lump. With knowledge of the dynamic viscosity of the glass in the return flow, it is possible to determine the speed gradient of the flow by simply reversing the law of friction. For a selectable, preferably always identical depth in respect of the glass bath under the batch, it is possible to ascertain therefrom a relative speed as a characteristic parameter in respect of the glass return flow speed. If the forces of the batch forward movement consisting of infeed impulse and slope downward pressure are continuously decreasing and locally put into a condition of equilibrium with the frictional force of the glass return flow near the surface, then for each batch lump size there is a defined equilibrium position in the direction of forward movement of the batch, because of the decreasing size of the batch lump. In that case the forward thrust of the batch for the smaller old lumps on the far side of the feeder machine after the falling incline, even in the ‘valley’, in front of the source point, does not become zero because the growing relative melting-away mass of the batch lumps, with the impulse of the melting-away effect which is oriented predominantly rearwardly (due to relatively great surface solid body resistance in that direction) and a relatively higher level of intake of material to be melted into the gaps which are therebetween, still persists. At the same time with the opposing force of the recirculation flow for two reasons a reduction is to be assumed to occur, which also promotes the forward movement of the small old lumps: firstly the speed of the return flow is relatively constant for balance sheet reasons on the longitudinal axis but its temperature falls on the return path with the beginning of contacting with the increasingly closed batch cover, due to mixing in cold molten material and simultaneous radiation screening for the flow beneath the batch cover. In that situation its viscosity rises and therewith the returning force, in accordance with Newton's law of friction, as the speed remains constant. Secondly, the batch lumps which have moved far forward, as they move in the direction of the source point, become continuously thinner and increasingly approach the above-indicated simplification assumption of a plate on the surface. In that situation however their end resistance which also depends greatly on the thickness of the lump also becomes less. At least those two arguments are in support of the relatively great forward feed travel of old lumps towards the end of their existence.

In particular the apparent absence of strongly acting mechanisms which oppose the occurrence of an equilibrium position in respect of the batch islands in depends on their configuration is advantageous in terms of the measurement method. That essentially forms the basis for the prospect of success with the method according to the invention of being able to more extensively ascertain a relative strength of the recirculation flow, due to the batch distribution. In spite of the high level of dynamics of the image in a practical context, it was surprisingly found that the positioning of the proportionate surfaces of the batch in general, as in consideration of the complexity of the process, is reproduced very well by a significantly linear pattern. That applies in regard to the portion which adjoins the closed layer of batch immediately after the infeed zone. What is particularly amazing and pleasing however is that the rise in that linear portion surprisingly actually represents a characteristic number in respect of the strength of the recirculation return flow. In that respect, in particular because of the complexity and lack of clarity of a description in terms of a model, it is immaterial how that correlation is to be precisely defined. On the contrary: continuous reproducible measurement, as is disclosed here with the method according to the invention, remains indispensable even at the highest technological level.

In the first uses the tan function (or the rise) in the batch coverage on the longitudinal axis of the melting furnace is (preferably) assumed in opposite relationship to the main flow direction of the glass and used to determine the relative strength of the recirculation flow from the batch coverage image. The characteristic numerator position for a relative speed is in that respect completely sufficient for measurement purposes or as an actual value for regulation procedures. Measurement of the compression or packing density of the batch lumps, expressed by the gradient of the straight line, with the mode of operation of the feeder machines remaining the same, actually also results in a high level of coincidence with the strength of the comparatively diagnostically measured, surface recirculation return flow.

Clarification and logically necessary interlinking of the dynamically favourable regulating parameters for quality assurance is an essential component of the invention.

An image evaluation method which distinguishes brightnesses in pixel-wise manner on the surface of the glass bath and detects same in line-wise proportionate fashion is used for distinguishing batch-covered surfaces and surfaces which are free thereof in a freely selectable image section of the glass bath surface. In that way it is possible to ascertain the reduction in the degree of batch coverage in the melting direction, which is directly related to the strength of the surface recirculation flow and in particular indicates the stability thereof. That is the required measurement value of an actual parameter for the construction of a regulating circuit which is relevant in terms of quality. In order to close a suitable regulating circuit for the recirculation flow however a suitable control parameter is also required. Old and well-established limits in respect of technological room for manoeuvre have to be overcome for that purpose, which exist in relation to transverse flame furnaces in particular in regard to fuel distribution along the longitudinal axis of the furnace tank.

Fuel distribution which is mostly empirically selected and generally doggedly continuously kept constant is attributed with a new dynamic function as a control parameter of a regulating circuit. The regulating circuit however cannot be at the top in the regulating hierarchy of the furnace. On the other hand the success of the new regulating procedure is directly dependent on meaningful incorporation into the structure of the furnace regulating process. What presents itself as hierarchically superior regulation is regulation of the degree of batch coverage which is ascertained optically in accordance with claim 16, as set forth by the method of claim 1, wherein same has an output which predetermines a fuel or total energy involvement. Constant fuel regulation or FTR at the top of the regulation concept is also possible but is less efficient.

Incorporation into a fuzzy regulating procedure or the concept of the upper furnace temperature regulating circuit at the top of a cascade is in contrast absurd in terms of the method. With FTR it is advantageous that the undoubtedly good properties, which are relevant to safety engineering, of furnace roof temperature regulation are preserved even with better dynamics.

In accordance with the invention therefore, for glass-melting furnaces as set forth in claim 2 there is proposed a regulating method for regulation of the gradient of the batch coverage, which in the cascade relationship or as a subsequent regulator has an input for the total fuel or the fossil energy usage, has as the set value a gradient in respect of batch coverage, as the actual value uses the gradient of the batch coverage from the per se known evaluation of a CCD camera image at the pause times of the change operation, and responds to low gradients of batch coverage, that is to say a batch which floats far forwardly with a loose arrangement of the batch lumps, with distribution of the energy input more greatly in the direction of the source point, and which has a regulating response which, in the case of a closely compacted batch, with a gradient in respect of batch coverage which is less than the predetermined set value, displaces the energy distribution in the case of transverse flame furnaces in accordance with claim 7 to an increased degree in relation to port 1 at the infeed region or the port at the source point and thus increases the recirculation flow. For U- and transverse flame furnaces the increase in the bubbling throughput in accordance with claim 5 and electroboosting in accordance with claim 6 in the source point area are control parameters in the same direction of the batch drift regulating circuit. Glass flows are substantially laminar creep flows which, as in the case of the recirculation return flow, driven only in one direction, have a very slight transverse mixing effect.

As is known, besides the source point temperature for the refining procedure, good reaction space separation and good mixing by virtue of high shearing forces in the glass are an essential prerequisite for homogenisation of the glass, that is to say for the quality of the glass.

Effective cross-flow mixing occurs only in the combination of an axial recirculation flow and a radial recirculation flow, that is to say in particular by reinforcing the hitherto undervalued transverse mixing component. In the matched combination of those two there is a substantially higher potential in respect of the mixing action in the lower furnace, which denotes melting efficiency and quality assurance. In accordance with the invention proposed for that purpose is a consequential regulating means whose control regulator as the actual value has the numerical signal of a per se known optical image evaluation system ‘optical melting control (OMC) system’, wherein the information from the measurement procedure is the position of the focal point of at least one hotspot within a temperature field, axially in respect of the flame, on the surface of the glass on the transverse axis of the furnace, the set value of which is a length which is the position of a maximum of a temperature field preferably at half of the transverse axis of the furnace, the output of which is a control parameter in respect of the flame length which as an actual value of the subsequent regulator has the position, measured by means of OMC, of a heat source focal point as an expression of the flame length, and that the consequential regulator has an output which is a control parameter for altering the flame length by the position of a swirl member or the setting of the atomiser gas pressure or the setting of the load distribution of a port. In that respect, in the case of transverse flame furnaces, a focal point of the heat input into the glass bath is firstly determined by means of OMC by a control regulator, at a temperature field which is axial in respect of the flame, preferably for each flame axis. In the case of regeneratively heated furnaces that is preferably effected in each change pause. That heat focal point is compared in the control regulator to the set value which is in the same direction in terms of content and which is preferably half of the furnace width. When the set value and the actual value coincide those are the best conditions for reinforcing the transverse flow for the local hotspot, in particular its focal point of the flame in question, is near the longitudinal axis of the furnace at the center thereof.

What is essential with the method according to the invention is that equally the transverse flow of the gas is forced by the method as set forth in claim 3 and thus a strong cross-flow mixing effect is ensured. In that respect the focal point of the introduction of heat in the change pauses is locally determined and adjusted to a set value which is on the longitudinal axis of the furnace.

That set value of the control regulator is thus of a fixed optimum value which at any event is to be modified by the safety-relevant compulsion of interference parameters. The preferably PID-modified output of the control regulator is in the transferred sense a control parameter in respect of the flame length for the subsequent regulator. It is the controlled correction of the position of a flame heat focal point which is fed as an actual value to the subsequent regulator by an OMC. The result of this is that, in the event of an excessively close position of the local glass bath hotspot to the flame root, the control parameter of the flame length is increased by the control regulator (although particularly slowly). The quick consequential regulator compares the relatively quick actual value of the flame length to the control parameter which is predetermined by the control regulator, also preferably as a PID-regulator, and has a setting output which sets the flame length (or more precisely the focal point of a hotspot flame temperature field). The setting member in that respect is for oil-heated furnaces the reducing setting valve of the atomiser gas pressure and for fuel firing generally, the distributor valves for distributing the fuel to a port. In that respect flames which are preset in converging relationship are advantageously particularly setting-sensitive. In the case of gas burners the position of turbulence-intensifying swirl members or the position of the air setting valve of a per se known propellent air infeed arrangement which is preferably at the center of the burner are preferably setting parameters of the subsequent regulator. The flame length however is not unlimitedly adjustable in respect of length within the furnace. What is essential are safety-engineering demands which are in conflict with a very long flame. In particular, the port which draws off at the discharge gas side is not to be endangered by overheating. On the one hand therefore a limit value in respect of overheating is established and measured as a temperature gradient with an OMC, by per se known ambient comparison, but in a novel fashion at the edges of the burner mouths. On the other hand possibly also in accordance with subjective operator requirements the maximum flame length, as the location of the visible end of the flame, which is referred to as the burn-out length of the flame, can be established as a limit value and continuously measured by means of the OMC. Both comparisons are alternative disturbance variable feed-forward systems of the control regulator, which are subtractively superimposed on the set value thereof when the limit value is exceeded, so that the set value position of the hotspot on the glass is shortened from the central position towards the fire-controlling side. There is no provision for displacement beyond the central position.

Another way of resolving that problem involves making a comparison of the light output comprising the integration product of brightness and surface area filling of preferably three image strips which are parallel to the side wall and symmetrical, in the period of compensated set values in respect of the feed of fuel, to the burners. In that situation, a limit value in respect of the proportion of the image strip near the draw-off in the sum of the three strips is established. Incorporation of the limit value being exceeded is then effected as set forth above.

It is only in the preferable set value position that a continuous transverse source flow position is possible independently of the side involved and is regulated by a procedure whereby the flame length is so adjusted and regulated in accordance with a thermal focal point of its image as set forth in claim 4 in current fashion and in respect of the fire period, in such a way that the hotspots which are axial of the flame are near the ideal position in relation to the longitudinal axis of the furnace, wherein the flame length regulating circuit as set forth in claim 10 is controlled by the regulating circuit as set forth in claim 3. The flame length is set to be greater as set forth in claim 8 in the case of oil burners by a reduction in the atomiser gas pressure. Asymmetrical distribution of the fuel to the burners within a port as set forth in claim 9 is a suitable means according to the invention for increasing the length of gas and oil flames, in particular if the axes of the flames converge or intersect. In order to counteract the risk of excessively long flames, claim 11 provides that there is superimposed on the control parameter of the flame length a disturbance variable which, as set forth in claim 23, is an optical measurement parameter which monitors local overheating at the end of the flame, in particular at the edges of the port drawing off exhaust gas, in the change pause. Optical measurement however is directed in particular as set forth in claim 12 towards the glass bath surface. The limits of the evaluation image portion are preferably fixed manually in such a way that the surface of the glass which can be completely viewed by the furnace chamber camera is incorporated. Bubbling spots or contamination at the camera inspection hole, which project into the image, are however kept out as an exclusion from evaluation. In order to detect the cause of the hotspot on the surface of the glass and for regulation of the flame length, in accordance with the current fire situation, claim 13 provides that associated with each port is a flame axis which is preferably not rendered visible in the evaluation image.

Batch coverage and batch drift as set forth in claim 1 and claim 2 should if possible have no trapezoidal distortion and should be numerical values which are close to reality, as set forth in claim 21. Therefore, each pixel as set forth in claim 14 is corrected in respect of weighting quadratically in relation to its spacing from the image recording. As set forth in claim 15 lateral distortion is allowed, which results in a lower value in respect of a laterally disposed batch. That is an advantage because of the ideal situation of V-shaped introduction for the regulation effect as set forth in claim 2, and in addition is algorithmically particularly simple.

In accordance with claim 17 batch compression is preferably also graphically represented as a rise in batch coverage in opposition to the removal flow direction of the glass, in which respect however the numerically determined linearised rise is the input actual value of the regulating procedure as set forth in claim 2. The distinction in respect of a criterion both in the case of gray shades as set forth in claim 14 and also in the case of color intensity comparison as set forth in claim 20, as a batch or glass, is adapted by the comparison to two respective prevailing standards of the particularly hot first and particularly cold last lines in respect of long-term dynamics as set forth in claim 18 for brightness levels and as set forth in claim 22 for colors of the changing thermal furnace situation. For image evaluation it is advantageous, in accordance with claim 19, to have the direction of view on the longitudinal axis of the furnace and thus to arrange the image lines in the transverse direction of the furnace tank. As the direction of the recirculation flow which is to be regulated in accordance with claim 2 and measured in accordance with claim 17 is in opposite relation to the removal flow, numbering in that direction is allocated to the lines.

The commercial advantages of the method over the known state of the art lie in the higher level of quality assurance in regard to the glass melt of mass-produced glasses, a higher level of available specific melting efficiency with comparable quality, a reduced level of energy consumption, and possibly an increased installation service life. In the majority of uses a reduction in waste gas NOx emission is to be expected.

The invention is described hereinafter with reference to embodiments by way of example. In the drawings:

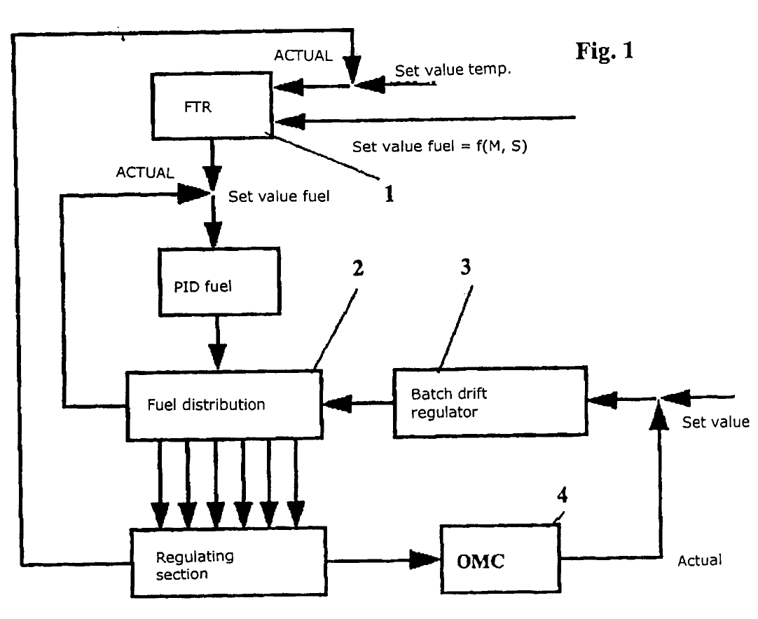

FIG. 1 is a diagrammatic view of the regulating circuit according to the invention for intensity regulation of the main recirculation flow of the gas, near the surface,

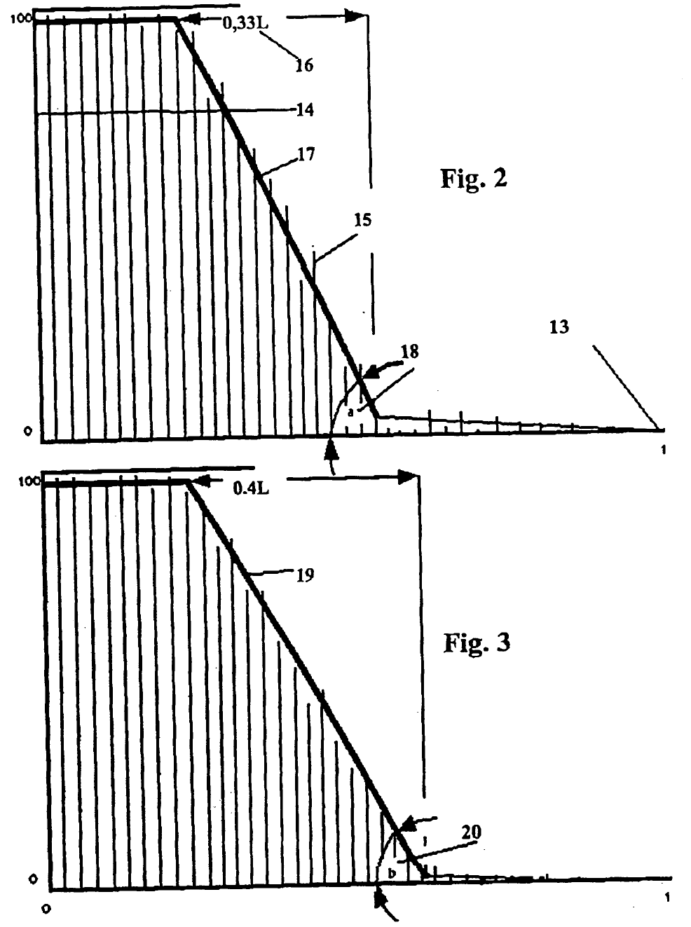

FIG. 2 shows the measurement result of an OMC measuring system which forms the input of the batch drift regulating circuit according to the invention,

FIG. 3 shows a material value curve of OMC measurement as shown in FIG. 2,

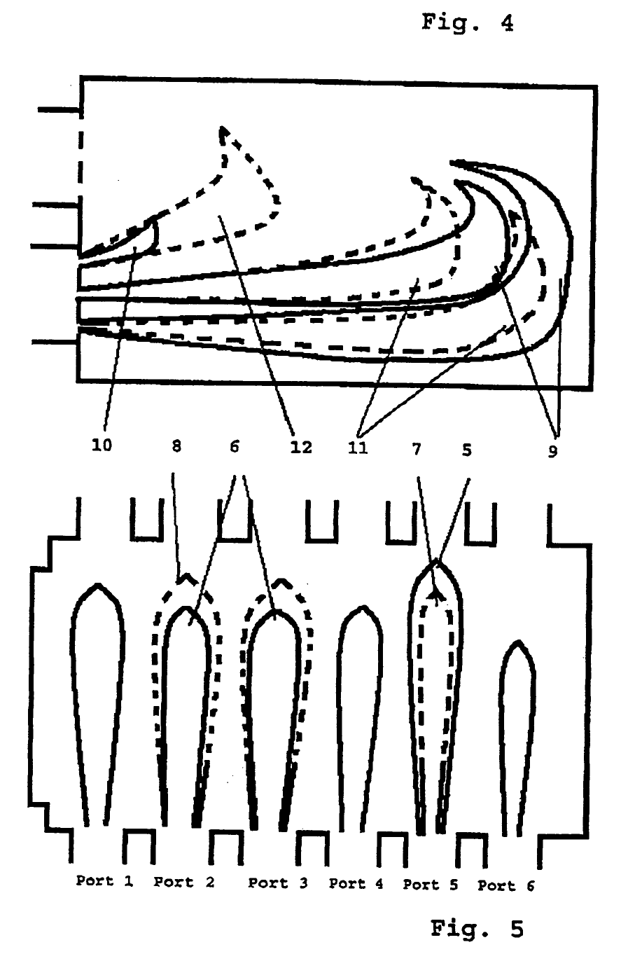

FIG. 4 is a view of the setting procedure at the regulating section as a variation in the flame size on a transverse flame furnace,

FIG. 5 is a view of the thermal load of the refining zone in the initial situation and with subsequent regulation, and

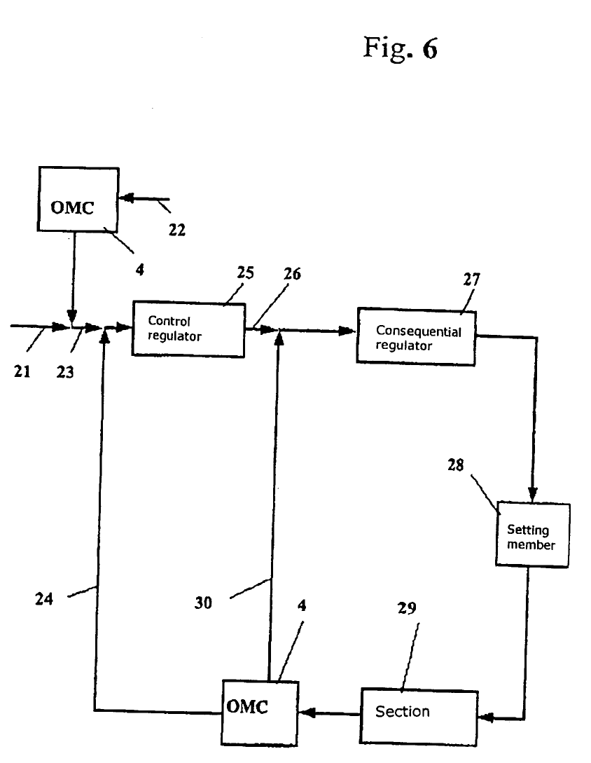

FIG. 6 is a diagrammatic view of the regulating circuit according to the invention for intensity regulation of the transverse recirculation flow of the glass, near the surface.

The implementation of the method as set forth in claim 2 will firstly be described in greater detail, by means of a first embodiment. A float glass furnace tank is operated predominantly in an automatic fuel mode using a technological operating procedure in which set value or reference value presetting in respect of the overall supply of fuel is effected in dependence on melting capacity and efficiency and cullet proportion. Specifically that is implemented by a regulator which is known per se as the FTR 1 which has the advantage of parallel furnace roof temperature monitoring. The method of batch coverage regulation as set forth in claim 1, which is very simple in itself in terms of principle, at the top of the regulator hierarchy, is on this furnace still in time-wise and test-wise open-loop testing. A conventional PID-regulator for the overall fuel is arranged downstream of the FTR used in the example. All ports are equipped with lambda regulation. Each port has a separate reference value presetting for the air ratio lambda. That adequately ensures that changes in thermal loading at individual ports are well correlated with the fuel feed thereof and are not even in opposite relationship. The distribution of the fuel for the individual ports, as a proportion of the overall fuel feed, is stored in the set value generators of a fuel distribution means 2, which are manually adjusted by way of a process control system. The surface of the melt is monitored with a conventional furnace chamber camera and the smelting gradient of the batch on the longitudinal axis of the furnace tank is measured by the method as set forth in claim 17, wherein the measuring device is referred to as an optical melting control system (OMC) 4. The rise in batch coverage in the melting zone in the region of near 0 to near 100% batch coverage is measured by the OMC line-wise on the transverse axis and is determined in the direction of the surface recirculation flow by means of a simply linear approximation. The rise therein is the actual value of the batch drift regulating circuit according to the invention. A good value in respect of the rise has been ascertained for the melting efficiency from long-term comparative observation on the part of the operator of quality and OMC output in the form of the numerical rise in batch compression. That is the manually predetermined set value of the batch drift regulator 3.

FIG. 2 shows the measurement result of an OMC measuring system which forms the input of the batch drift regulating circuit 3 according to the invention. Therein the furnace tank length is represented as the abscissa 13 in the molten material flow direction. In addition batch coverage is represented in the transverse direction as the ordinate 14. Although each image line is individually measured by the system, to smooth the image line scatter a respective mean value of batch coverage of a plurality of lines has been formed and is illustrated as a column which is the percentage batch coverage of an image line group 15. By means of simply linear regression the main limb of the rise in batch coverage is determined as a main approximation straight line of batch coverage in the melting zone 17. The length of the adjacent line thereto is the current proportional length of the melting zone 16. The numerical rise which is the quotient of the opposite adjacent side and the adjacent side is used as the input signal for the regulating procedure. In the example the opposite adjacent side is 0.92 as the increase was ascertained for the range of 5% to 97% batch coverage. In other words, the amount 1=100% was reduced by 0.005 and 0.3. The amount of the adjacent side is 0.33. The actual value of the regulating section is thus: 2.79. The angle of rise of the approximated batch compression 18 is the tangent to that quotient and is of a rather vivid value. For this situation also however for the adjacent side, the value thereof is desirably also used. In content terms, this is justified in that the surface recirculation flow, the effect of which is determined here, is in the opposite direction to the abscissa 13, but for reasons of clarity the furnace tank length as usual is illustrated in the flow direction.

FIG. 3 shows the associated stored good value curve in respect of the OMC measurement. The main approximation straight line of a good value store 19 exhibits good correlation with the individual values up to 2% batch coverage. The quality-assuring rise angle of batch compression of a good value store 20 is shallower than the actual value. For the regulating procedure however the digital rise is essential. In the good value which for the same tonnage forms the actual value of the batch drift regulating circuit, that is: 2.35. The regulating deviation is −0.44 and the example thus shows that the regulating deviation is advantageously spread greatly towards high values.

The fuel distribution is varied in the illustrated example exclusively between port 2 plus port 3, as an alternative to port 5 which is the ‘source point port’. The regulating deviation is assessed with a PID-characteristic in the batch drift regulator and fed as a set value to the fuel distributor component 2. That reduces the proportion of the fuel for the ‘source point port’, the port 5, in which respect the fuel distributor at the same time increases the proportion for the sum of ports 2 and 3 distributed equally by the same amount. The function thereof is in this respect to keep the sum of the proportions of ports 2+3+5 constant. The regulator output of the regulating circuit 3 according to the invention is thus the input of the fuel distributor component 2 for set value control in the manner of correction of manual presetting. In the present example the admissible range of the set value correction is set to be limited to 3% in each case of the total fuel involvement. Magnitudes of the set parameter as the output of the batch drift regulator 3, which go therebeyond, are not implemented but displayed. At the same time they acquire the status of an operating proposal for manual operation and for that purpose are emphasised in color on the operating monitor. The total fuel presetting as a set value in respect of fuel is the output of the per se known higher-level fuel temperature regulator (FTR) 1 and the input of the per se known fuel regulator. The fuel temperature regulator 1 characteristically presets equal set values in respect of the total fuel, over relatively long times, thereby avoiding systematic or coupled superimposition of setting operations due to fuel changes. In the illustrated example the fuel distributor component 2 is arranged downstream of the fuel regulator. Alternatively, it is recommended that the provided set value input of the fuel regulator should be used as the input of the fuel distributor component 2.

FIG. 1 does not show the individual fuel regulators which in the real installation are arranged downstream of the fuel distributor. Adjustment of the dynamic regulating parameters is effected in the context of routine activity on the part of the man skilled in the art. In the illustrated example, because of the measurement values of the OMC, which occur individually only every 20 minutes in relation to the respective change pause, the regulator was initially operated as a P-regulator, then the I-component was actively used and to continue as a precaution the differential component was increased. It is inappropriate for the delay times to fall below 2 hours. Integrating repetition below 1 hour is equally inappropriate (I-component).

FIGS. 4 and 5 are views showing in a clear and simplified fashion the setting procedure at the regulating section as a variation in the flame size. In this case the representation of the flame size is used as an alternative as a graphic representation for supplying fuel to the port in question or the burner. In this respect FIG. 4 shows the setting operation on a transverse flame furnace tank as a reaction of the batch drift regulator to the regulating deviation in accordance with the above-mentioned example with excessively displaced batch position in the smelting zone. In this respect the magnitude of the fifth flame in solid-line contours symbolically represents the relative heat loading at the source point in the initial situation 5. That is reduced as the setting operation of the batch drift regulator in order to weaken the source point. The broken-line contour of the flame symbolically shows the relative heat load, with subsequent regulation 7, at the source point. The heat load at ports 2 and 3 in the initial situation 6 is symbolically indicated by the surface area of the second and third flames. The setting condition of the fuel distributor component is to keep the sum of the fuel from ports 2+3+5 constant. The consequence of this is that the heat load at port 2, when post-regulated 8, just as at port 3, is greater than in the initial situation.

For a U-flame furnace tank the concept of regulation of entire burner ports is transferred to individual burners. FIG. 5 shows the heat load of the refining zone in the initial situation 9 and the heat load of the refining zone when post-regulated 11, symbolically illustrated as reduced flame sizes. The consequence over the flame distributor component for the third flame arranged transversely over the intake region and the smelting zone is symbolised with the change in the flame sizes from the separate heat load of the smelting zone in the initial situation 10, towards the separate heat load of the melting zone, when post-regulated as indicated at 12.

To carry out the method as set forth in claims 3 and 4 the system for optical control of the glass melt, the ‘optical melting control system’ (OMC) 4, measures in the illustrated example the color intensities blue, green and red on the glass bath. As is known per se, temperature fields with isotherms are used. In this case troublesome cold regions (batch islands) are converted in respect of calculation. Within an isotherm a hotspot on the glass surface is transcribed and ascertained as set forth in claim 3 and claim 12. In the case of regenerative furnaces that is preferably effected within the change pause in firing. The geometrical center point of the hotspot is determined and associated with a pixel. The image lines are associated with a burner port by the preselection of a flame axis, in accordance with claim 13. That provides for determining the burner port causing the situation. The position of the geometrical center point of the temperature field, which is axial in respect of the flame, on the glass is assessed as the actual value of the control regulator 25 in FIG. 6 as the position axially in respect of the flame of the focal point of a hotspot temperature field on the glass bath 24 and is specifically the current position thereof as a lengthwise component on the transverse axis. From the fixed bird's-eye view of the furnace chamber camera on the central axis of the furnace tank the central pixels of the symmetrical image section form the central axis on the glass bath. It is there that the current focal point of the heat sink for each flame should be. In accordance with claim 3 this is the reference or set position of the focal point of a temperature field, axial in respect of the flame, of the heat sink 21, the preferably fixedly adjusted set value of the control regulator 25, which is half a furnace tank width. In the example illustrated there is a regulating deviation. The actual value as the position, axially of the flame, of the focal point of a hotspot temperature field on the glass bath 24, as viewed from the previous flame root which has just been switched off, is in the illustrated example in front of the set value. This means that the flame evidently delivered its heat too early to form a focal point of the heat loading on the central axis of the furnace tank within a temperature field axially of the flame, as is desired, and thus to drive the rising transverse flow in the central position. The flame is set somewhat too short for that purpose. The control regulator or heat sink regulator 25 changes the control parameter flame length 26 of the consequential regulator 27, clearly the fast flame length regulator 27, towards a greater flame length. That control parameter becomes active with renewed initiation of firing at that side and the regulator 27 now currently regulates a ‘longer’ flame. That length of the flame is also measured by means of the OMC 4, more specifically entirely similarly but in the firing period and continuously over a longer time. A focal point of the flame is formed within an isotherm, the relative length of which is determined by the furnace tank width, referred to for the sake of simplicity as the actual value of the flame length 30. The flame is associated with a port and the regulating circuit is closed by virtue of the fact that the excessively short flame is increased in length by a setting action on the part of the consequential regulator 27, which is superimposed on the setting member for the flame length 28. In the example, in accordance with claim 8, the atomiser gas pressure of the oil burners is lowered at that port. The image at the regulating section 29 changes in respect of the shape of the glass bath surface temperature distribution and the wall temperature distribution. These are the input of OMC image processing in the regulating circuit. The regulator 27 continues to operate autonomously during the time of the firing period on the basis of the control parameter which has been altered for half the firing period, and automatically adjusts all flame length alterations from distance changes in that period. We should just recall disturbances arising out of changes in air feed to the port or furnace chamber pressure fluctuations, in order to clearly show the requirement for the regulator to be up-to-date. In the next cycle for example coincidence of the brightest location on the glass bath and the central axis of the furnace tank is to be seen. In that case the control regulator 25 will not cause any alteration in the control parameter of the consequential regulator 27 and the latter in the next cycle operates with the old control parameter of the flame length. The regulating circuit for the flame length can also be uncoupled from the control regulator 25, but can then be operated alone for stabilisation of a for example subjectively wanted flame length. The control parameter which is outputted in a complete configuration by the control regulator 25 then advances to the set value of the flame regulator 27. In the illustrated example regulation of only one flame length in accordance with claim 4 is depicted for regulating the associated hotspot into the central position of the furnace tank in accordance with claim 3 by means of the method in accordance with claim 10. Particularly for transverse flame furnace tanks a plurality of such regulating circuits are provided, but generally they jointly use exclusively one OMC system 4.

The success of the method is strikingly demonstrated on a more greatly V-shaped configuration of the intake image and can be numerically relatively determined as such by the OMC 4, independently of the present invention. In accordance with claim 2 the withdrawing port of an oppositely disposed flame length-regulated port on a transverse flame furnace tank is to be protected from serious overheating by limit length monitoring in accordance with claim 11. The disturbance variable edge overheating of the burner mouth 22 is to be avoided. In accordance with claim 23 image evaluation by means of the OMC in the firing pause immediately after ‘fire out’ is implemented for a manually selected image section at the furnace side wall which is in the proximity of the port in question, but excludes that port itself. As a result distribution of the intensities of blue, green and yellow is determined for the surface involved. Almost at the same time the same thing is implemented with the inclusion of the port edges. A relative blue shift which is classified as critical, with the inclusion of the burner mouth edges, which is set by hand, outputs by way of the OMC 4 a proportional signal in respect of the proportionate blue shift which is subtracted from the manually set reference or set value of the control regulator, the set position of the focal point of the heat sink 21 axially of the flame. The result is the safety-corrected set value in respect of the heat sink regulator 23. That set value is set back from the ideal central position, to the benefit of thermally conserving the withdrawing port.

In the case of U-flame furnace tanks fuel distribution of the burners of the firing port and supporting air distribution at the port are the slightly differing setting parameters which are to be transferred in corresponding manner from the description for the transverse flame furnace tank in the context of routine engineering activity.

1. A method for regulation of quality-determining parameters of the rough melt in glass-melting furnaces, characterised by regulation of the optically measured proportion of the batch coverage of the glass bath surface as an actual value input, by means of a batch coverage regulating circuit whose set value is a degree of batch coverage and whose output is the total energy supply.

2. A method for regulation of quality-determining parameters of the rough melt in glass-melting furnaces, characterised by intensity regulation of the main recirculation return flow of the glass which is near the surface, said intensity regulation being afforded by way of axial repulsion of the batch advancing in lump-wise manner, wherein regulation of the optically measured gradient of the degree of batch coverage in the direction of the longitudinal axis of the furnace tank is effected as an actual value input by means of a batch drift regulating circuit which is subordinate to an overall fuel regulating circuit and whose output is the control parameter of a subsequent regulating circuit which indirectly sets the flow of glass in the lower furnace.

3. A method for regulation of quality-determining parameters of the rough melt in transverse flame glass-melting furnaces, which is recognisable by way of lateral V-shaped repulsion of batch advancing in lump-wise manner, characterised by intensity regulation of the transverse recirculation flow of the glass which is near the surface, wherein the position axially of the flame of the optically measured focal point of a hotspot is regulated in a flame track on the surface of the glass, which is the actual value input of a firing control regulating circuit, the preferred set value of which is the central position of the hotspot in the transverse direction of the furnace tank and the output of which is the control parameter of a subsequent regulating circuit which sets the flame length.

4. A method for regulation of quality-determining parameters of the rough melt in glass-melting furnaces and for furnace-preserving firing control, characterised by regulation of an actual value which is the optically measured position of the focal point of a hotspot flame temperature field of a combustion air port, wherein the regulating circuit is a flame length regulating circuit with a set value which is the hotspot position on the flame axis.

5. A method for regulation of quality-determining parameters of the rough melt in glass-melting furnaces as set forth in claim 2 characterised in that a subsequent regulating circuit sets the glass flow in the lower furnace by setting action, in the same direction, of the bubbling effect near the source point.

6. A method for regulation of quality-determining parameters of the rough melt in glass-melting furnaces as set forth in claim 2 characterised in that a subsequent regulating circuit sets the glass flow in the lower furnace by setting action, in the same direction, of the additional electrical heating effect near the source point.

7. A method for regulation of quality-determining parameters of the rough melt in glass-melting furnaces as set forth in claim 2 characterised in that in the case of transverse flame glass-melting furnaces a subsequent regulating circuit increases the glass flow in the lower furnace by setting of the fuel distribution to the ports by a procedure whereby the source point port and/or port 1 are proportionately increasedly supplied with fuel.

8. A method for regulation of quality-determining parameters of the rough melt in glass-melting furnaces and for furnace-preserving firing control as set forth in claim 4 characterised in that the output of the flame length regulating circuit is a setting parameter which in inverted sense sets the flame length by the atomiser gas pressure from oil burners.

9. A method for regulation of quality-determining parameters of the rough melt in glass-melting furnaces and for furnace-preserving firing control as set forth in claim 4 characterised in that the output of the flame length regulating circuit is a setting parameter which sets the flame length by asymmetrical fuel distribution to the burners of a port, wherein the increase in the degree of inequality sets longer flames.

10. A method for regulation of quality-determining parameters of the rough melt in glass-melting furnaces as set forth in claims 3 and 4 characterised in that the set value of the flame length regulating circuit is passed as a control parameter from the firing control regulating circuit and that its output is a setting parameter which sets the flame length.

11. A method for regulation of quality-determining parameters of the rough melt in glass-melting furnaces as set forth in claim 10 characterised in that the set value of the flame length regulating circuit is passed as a control parameter from the firing control regulating circuit and has a disturbance variable forward-feed means for limit length monitoring.

12. A method for measurement value production by furnace chamber image evaluation characterised in that image evaluation is executed locally within an image section which includes the glass bath surface visible in the camera perspective including the floating batch but excluding the upper furnace side walls.

13. A method for measurement value production by furnace chamber image evaluation for carrying out the method as set forth in claims 3 and 4 characterised in that image evaluation is effected in respect of time in the firing period and locally within an image section which includes the upper furnace chamber visible in the camera perspective, and that the association of a flame temperature field with a flame is effected by symmetry comparison with a flame axis which is preselected in the image.

14. A method for measurement value production by furnace chamber image evaluation as set forth in claim 12 for carrying out the method as set forth in claims 1 through 4 characterised in that within the image section the perspective reduction in spacings between the lines and columns of the image matrix is corrected by weighting of the pixels, which is proportional to the square of the spacing between the associated real object and the objective of the image recording means.

15. A method for measurement value production by furnace chamber image evaluation as set forth in claim 12 for carrying out the method as set forth in claims 1 through 4 characterised in that within the image section the perspective reduction in spacings is corrected exclusively between the lines of the image matrix by a procedure in which an angle α between the longitudinal axis of the furnace tank in the plane of the glass bath and the objective of the image recording means is associated once in the image section with each pixel line and in that situation the perspective correction factor is 1:cos α.

16. A method for measurement value production by furnace chamber image evaluation as set forth in claim 12 for carrying out the method as set forth in claim 1 characterised in that in an image section which approximately includes the glass bath surface of the melting zone of a glass melting furnace, a batch coverage is ascertained as the sum of the surfaces of the batch lumps, and that the quotient of the batch surface with respect to the constant glass bath surface of the glass melting furnace is the batch coverage.

17. A method for measurement value production by furnace chamber image evaluation as set forth in claim 12 for carrying out the method as set forth in claim 2 characterised in that in the established image section the linearised increase in a level of batch coverage is determined in the region of the driving batch lumps by a procedure whereby by means of image evaluation the surface area of the loose batch coverage is determined as a field of the lines, which has pixels both in a light class which is distinguished by brightness values as a criterion and also in the alternative dark class, a quotient of the number of the dark pixels to the number of the line points is determined line-wise and the linearised increase in batch coverage is determined and the rise constant in respect of batch coverage as a function of the image line number, on the longitudinal axis of the furnace tank and in opposite relationship to the removal flow, is the characteristic number of the pulse of the recirculation flow and the input measurement parameter of the batch drift regulating circuit.

18. A method as set forth in claim 16 or claim 17 characterised in that the threshold value as a criterion in respect of the brightness of pixels is formed from the mean value of the brightness of the first image line, at the foot of the image section, and the mean value of the brightness of the last image line.

19. A method as set forth in claim 16 or claim 17 characterised in that the axis of the viewing direction is so oriented that with the height of the image section and the furnace tank longitudinal axis it forms approximately a common perpendicular plane with respect to the plane of the surface of the glass and that the pixels on perpendiculars to the axis of the viewing direction are the evaluation image lines and that the numbering of the evaluation image lines is in a direction rising from the base of the image section.

20. A method as set forth in claim 16 or claim 17 characterised in that the criterion threshold value of brightness is replaced by the intensity in particular of the colors red and green, wherein small amounts of red indicate melting batch and/or cold batch and small values of green in that respect signal cold batch so that ‘dark’ is replaced by red near 0 and green at small but not near 0, and ‘light’ is replaced by a preceding comparison, that blue is very great, red and green are both small or medium-large but both are not near 0.

21. A method as set forth in claim 20 characterised in that the criterion threshold values in respect of the intensity for blue, green and red are formed from their respective mean value of the mean values of the first and last lines.

22. A method as set forth in claim 14 or claim 15 and claim 16 or claim 17 characterised in that batch coverage is a reality-related surface area in that a quotient is formed from the number of dark pixels in the image section with the weighting thereof, with respect to the number of all pixels in the image section, including the weighting thereof.

23. A method for measurement value production by furnace chamber image evaluation as set forth in claim 4 for carrying out the method as set forth in claim 11 characterised in that limit length monitoring of the flame in the firing pause following the waste gas-conducting period on the previously withdrawing side of the furnace is effected in that the comparison of the mean values of the brightness of two image sections is implemented, wherein an image section includes the edges of the port mouth of the previously waste gas-withdrawing port and the second comparative image section is an outer surrounding area of the first-mentioned image section, including the first-mentioned image section itself, and that the fact of exceeding a tolerance upper limit sets an interference signal in respect of flame limit length monitoring.

24. A method for measurement value production by furnace chamber image evaluation as set forth in claim 4 characterised in that the measurement operation is effected in respect of time in the pause in the firing side change.
